(19) United States
(12) Patent Application Publication
(10) Pub. No.: US 2014/0352562 A1
(43) Pub. Date: Dec. 4, 2014

(54) Method and apparatus for digital pad printing

(71) Applicant: Willard Charles Raymond, JR., Plymouth, MN (US)

(72) Inventor: Willard Charles Raymond, JR., Plymouth, MN (US)

(21) Appl. No.: 13/986,713

(22) Filed: May 28, 2013

(51) Int. Cl. B41F 17/00

(52) U.S. Cl. CPC B41F 17/001
USPC 101/324; 347/2; 101/483; 101/333

(57) ABSTRACT

An improved method and apparatus used in pad printing is disclosed wherein a customized cliché is created from a generic cliché and a computer image of the desired printed output. The generic cliché contains a fine array of micro pockets on its inking surface. Ink jet printing ink is precisely deposited into the micro pockets at varying locations and amounts by the computer system and cured to harden the ink jet ink, which creates a customized cliché. Pad printing ink will adhere to the customized cliché in amounts in inverse proportion to the amount of ink jet printing ink deposited and cured on the customized cliché. The pattern of empty, partially filled and completely filled micro pockets in the customized cliché creates a gray scale image on the printed part.

### FIELD OF THE INVENTION

The invention relates to improvements in the field of pad printing.

### BACKGROUND

Pad printing is a printing process able to transfer a two dimensional image onto a three dimensional object. This accomplished using an indirect offset (gravure) printing process that involves an image being transferred from a cliché via a silicone printing pad onto a substrate or part. A traditional cliché is made of a ceramic material, photopolymer or steel, depending on the length of the production run, with harder materials typically being used for longer runs. The cliché is either chemically or laser etched to create recesses into the surface of the cliché, representing the design or graphic to be printed. The recesses are filled with pad printing ink which is then transferred from the cliché recesses to the pad and then onto the part being printed. Traditional clichés have a fixed recess pattern and cannot be changed; changing the graphic to be printed requires replacing the cliché with an entirely new cliché. This is an inefficient and expensive pad printing process for short production runs. Pad printing is used for printing on otherwise impossible products in many industries including medical, automotive, promotional, apparel, electronic objects, appliances, sports equipment and toys. It can also be used to deposit functional materials such as conductive inks, adhesives, dyes and lubricants.

Physical changes within the ink film both on the cliché and on the printing pad allow it to leave the etched image area in favor of adhering to the pad, and to subsequently release from the pad in favor of adhering to the substrate. The inherent pliability of the silicone printing pad allows it to pick up the image from a flat plane and transfer it to a variety of surfaces such as flat, cylindrical, spherical, compound angles, textures, concave or convex surfaces.

Pad printing requires the use of special pad printing inks that are pasty and/or tacky enough to adhere to the printing pad in a stable manner during the transfer process, yet remain liquid enough to be able to adhere to the substrate or part before drying or curing. Attempts have been made to apply a design onto the printing pad via a flat plate using an ink jet printing head, as disclosed in U.S. Pat. No. 6,276,266 to Dietz et al. and assigned to Illinois Tool Works, Glenview, Ill., the text of which is herein incorporated by reference. Dietz et al. uses a conventional ink jet head to first discharge a desired design or graphic positive image onto a flat surface containing a release media, then using a conventional printing pad to pick up the ink jet ink deposited on the flat surface and finally transferring it to the substrate or part. As disclosed, Dietz et al. is intended to be used for multicolor printing which traditionally requires multiple single shot operations to lay down each desired color. It has, however, been found that Dietz et al. often does not work as intended because of the nature of ink jet ink, which to be able to flow through the tiny apertures of an ink jet head, by necessity must be low viscosity (thin) and high enough surface tension to form droplets in flight. It has proven difficult to obtain an inkjet-able ink that has properties suitable for pad printing. The properties that are required to make an inkjet ink jet-able (low viscosity, moderate to high surface tension, small particle size) limit the ink's other performance characteristics. Problems include ink jet ink not properly adhering to the printing pad, often creating a smeared or imprecise transfer. Problems also include inkjet ink not adhering or performing well on the printed part. There are many pad printing inks and functional fluids that are printed with pad printing ink that have no equivalent version for ink jet printing. These include metallic inks and high viscosity function fluids.

Pad printing works well for high volume production where the same image is printed for long periods and image changes are infrequent. Pad printing has not been able to economically address production situations where images must change frequently. This has been especially true for multicolor applications where individual pad prints must be precisely registered to generate a composite image. What is clearly needed, then, is an improved pad printing method that allows automatic change over from one image to a new image while allowing the pad printer to apply traditional pad printing inks. The need for easy automatic changeover is magnified on color pad printing applications. Color pad printing applications require a series of individual pad printers, each printing an individual color, that are tied together with a material handling system that moves the parts being printed from one pad printer to the next. Changing images on multicolor pad printing installations has traditionally required multiple clichés to be replaced and their print locations precisely registered. This is a time consuming and expensive manual process. The ability to automatically print a new image in a precise location facilitates image changeover for multicolor pad printing installations.

### SUMMARY

In one embodiment the invention discloses a method of pad printing, wherein the method provides a generic cliché defining a first surface configured to contain a plurality of micro pockets conforming to a graphic design desired to be transferred to a substrate. A customized cliché is created by precisely depositing varying amounts of ink jet ink into at least some of the micro pockets in the generic cliché representing areas of the graphic design requiring gray scale tonal control to be printed on an eventually completed part. The ink jet ink is then cured to solidify the ink jet ink. Next, the customized cliché moved to a location containing a quantity of pad printing ink where the customized cliché contacts the pad printing ink, filling in the micro pockets with amounts of the pad printing ink in inverse proportion to the amount of cured ink jet ink previously deposited in each pocket. The customized cliché then contacts a printing pad to transfer the graphic design from the customized cliché to the printing pad. The graphic design is then transferred to the substrate by moving the pad printing inked printing pad to contact the substrate. Finally the printed substrate is dried to solidify and stabilize the pad printing ink. In another step the printing pad is also cleaned to prepare for a subsequent printing cycle.

In another embodiment, the invention discloses a cliché for use in pad printing, having a plate defining a first major surface defining a surface plane with a region on the first major surface representing a graphic image formed by a plurality of micro pockets extending below the surface plane of the first major surface. Varying amounts of ink jet ink are precisely deposited into at least some of the micro pockets in the cliché representing areas of the graphic design requiring gray scale tonal control of an eventually completed part. The ink jet ink is hardened by being cured, resulting in a three dimensional structure below the surface plane which, when contacted with a quantity of pad printing ink, allows the pad printing ink to be transferred from the cliché in a manner reflecting a variation of intensity of color, to a printing pad maintaining the variation of intensity of color.

In an alternative embodiment, the invention discloses a printing apparatus including a platform containing a plurality of functional stations able to move to various positions, with the platform being configured to precisely hold a cliché. The cliché is configured with a plurality of micro pockets, wherein the micro pockets containing precisely deposited varying amounts of ink jet ink into at least some of the micro pockets in the cliché representing areas of the graphic design requiring gray scale tonal control to be printed on an eventually completed part. The ink jet ink is hardened by being cured. An inking station is mounted on the platform to provide pad printing ink to the cliché. A transfer station containing a printing pad able to contact the pad printing inked cliché to transfer the pad printing ink from the cliché to the printing pad is also is also mounted on the platform. Also on the platform is a printing station where the pad printing inked printing pad transfers the pad printed ink to a substrate desired to be printed.

### BRIEF DESCRIPTION OF THE DRAWINGS

FIG. 1 is a flow chart illustrating the steps of the pad printing method.

FIG. 2 is a plan view of a generic cliché containing a plurality of recesses or micro pockets on a first surface prior to being treated with ink jet ink and curing of the ink jet ink.

FIG. 3 is a cross section of the generic cliché prior to being treated with ink jet ink and curing of the ink jet ink, wherein the micro pockets are empty and of a substantially uniform depth.

FIG. 4 is a plan view of an ink jet print head depositing ink jet ink into the micro pockets of the generic cliché.

FIG. 5 is a plan view of a customized cliché following being treated with ink jet ink and curing of the ink jet ink.

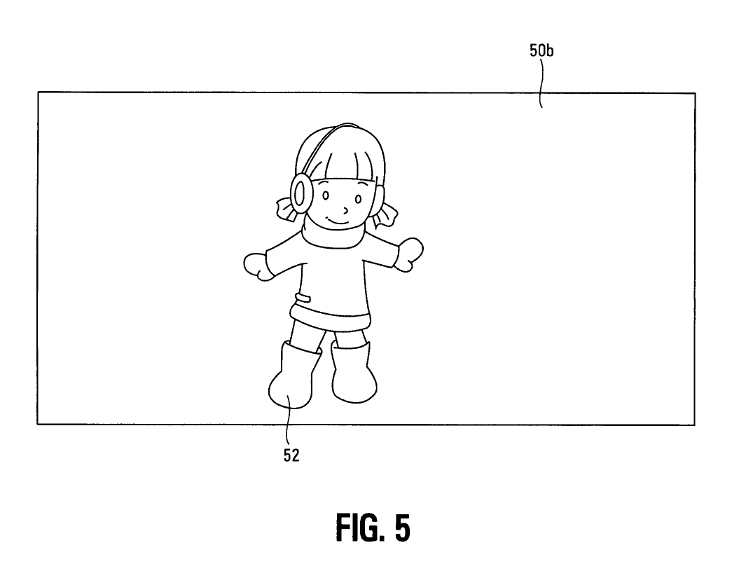

FIG. 6 is cross section of a customized cliché showing one pocket completely filled in with cured ink jet ink, a second pocket containing no ink jet ink and completely filled in with pad printing ink and a third pocket partly filled with cured ink jet ink and partly filled with pad printing ink.

FIG. 7 is a side view of a customized cliché being inked with pad printing ink.

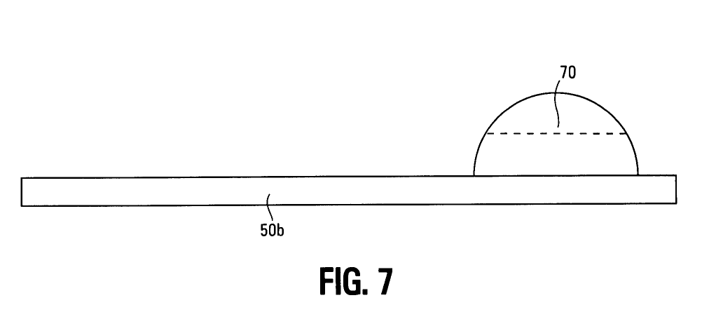

FIG. 8 is a side view of the substrate being contacted during the printing process, resulting in the transfer of the image.

FIG. 9 is a schematic view of the pad printing press.

FIG. 10 is a plan view of an embodiment of the invention where a plurality of printing presses is serially connected by a conveyor system.

### DETAILED DESCRIPTION

The particulars shown herein are by way of example and for purposes of illustrative discussion of the invention only and are presented in the cause of providing what is believed to be the most useful and readily understood description of the principles and conceptual aspects of the invention. In this regard, no attempt is made to show structural details of the invention in more detail than is necessary for the fundamental understanding of the invention, the description taken with the drawings making apparent to those skilled in the art how the several forms of the invention may be embodied in practice.

### NOMENCLATURE

10 Step of optionally moving the cliché to a first cleaning station.
12 Step of optionally cleaning the cliché to remove all cured inkjet ink from the array of micro pockets, making the cliché generic.
14 Step of optionally moving the generic cliché to the inkjet customization station.
16 Step of analyzing the computer input file of the desired image to be printed and generating a negative image.
18a Step of depositing inkjet ink where pad printing ink is not desired to be applied, based on the computer input file, resulting in a customized cliché.
18b Step of curing a negative image on the generic cliché with UV curable inkjet ink.
20 Step of optionally moving the customized cliché to the inking station.
22 Step of applying pad printing ink to the customized cliché. Micro pockets not completely filled with inkjet ink will be filled with pad printing ink.
24 Step of contacting the printing pad with the customized cliché. A pattern of ink is transferred to the printing pad.
26a Step of moving the printing pad over and down to contact the part.
26b Step of transferring the ink image to the part being printed.
28a Step of moving the printed part to the drying station.
28b Step of drying the printed part.
30 Step of optionally moving the printing pad to and pressing against a cleaning pad to remove any leftover ink from the printing pad.
46 First Major Surface
48 Second Major Surface
50a Generic Cliché
50b Customized Cliché
51 Surface Plane of First Major Surface
52 Graphic Design
53 Pocket
54 Cured Ink Jet Ink
56 Pad printing ink
58a Substrate (prior to printing)
58b Substrate (following printing)
60 Conveyor
62 Platform
64 Cleaning Station
66 Pad Transfer Station
68 Inking Station (pad printing ink)
70 Printing Pad
72 Printing Station
74 Drying Station
76 Inkjet Customization Station
78 Curing Station
100 Printing Press
102 Microprocessor
104 Power Supply
110 Ink Jet Head

### DEFINITIONS

“Customized cliché” refers to a generic cliché that has been precisely contacted with ink jet ink that is cured and hardened and in some places completely fills in the micro pocket, in some places partly fills in the micro pocket and in other places is completely missing from the micro pocket.

“Generic cliché” refers to cliché having a plurality of small micro pockets representing a two dimensional array of potential ink locations which could be printed, with the micro pockets extending a substantially uniform depth beneath the surface plane of the cliché.

“Graphic Design” or “Image” refers to the graphic desired to be printed on the substrate.

“Gray Scale” refers to the relative brightness or intensity of an image transferred to a part printed by the method of this invention.

“Ink Jet Ink” refers to an ink used in conventional ink jet printing that has low viscosity and high surface tension, allowing it to be precisely discharged, without clogging, through the small diameter nozzles of an ink jet head.

“Micro Pockets” refers to recesses extending below the surface plane in the generic and customized clichés that represents a graphic design to ultimately be printed onto a substrate.

“Pad Printing Ink” refers to a conventional paste-like ink that is relatively tacky allowing it to temporarily adhere to a printing pad before being permanently transferred to a substrate.

“Printing Pad” refers to a three dimensional silicone pad configured to pick up printing pad ink used to transfer a graphic design to a substrate.

“Substrate” refers to a part desired to print a graphic design on.

“Traditional Cliché” refers to a two dimensional plate containing etched sections representing a graphic image desired to be transferred to a substrate or part.

“UV Cure Ink Jet Ink” refers to inkjet ink that becomes solid when exposed to ultra violet light.

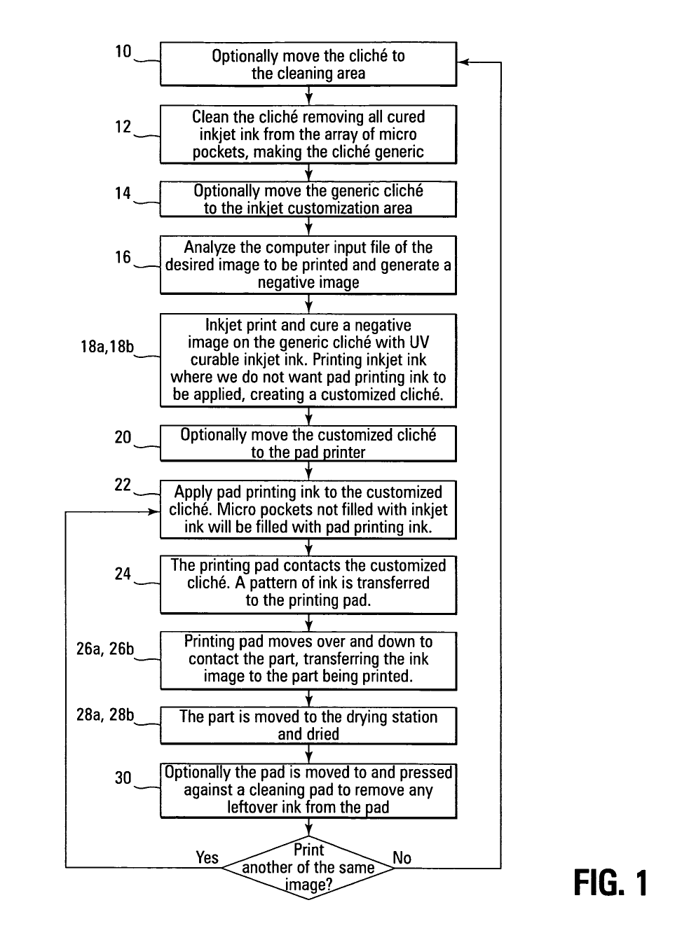

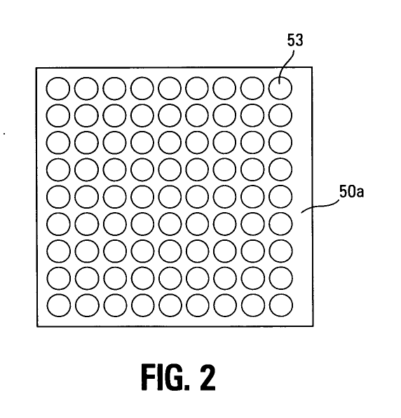

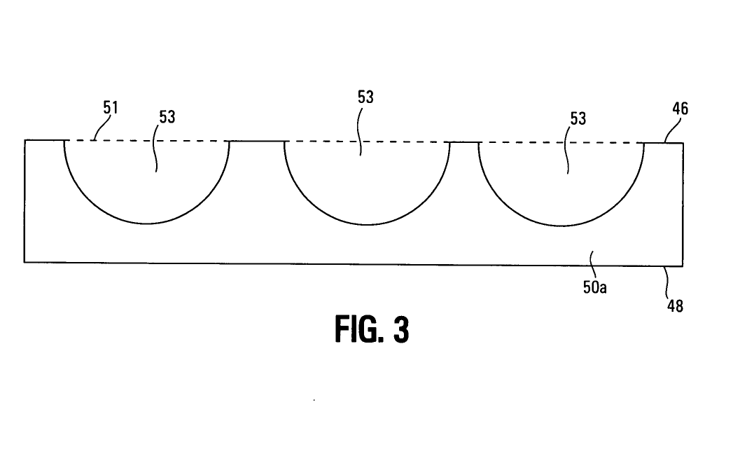

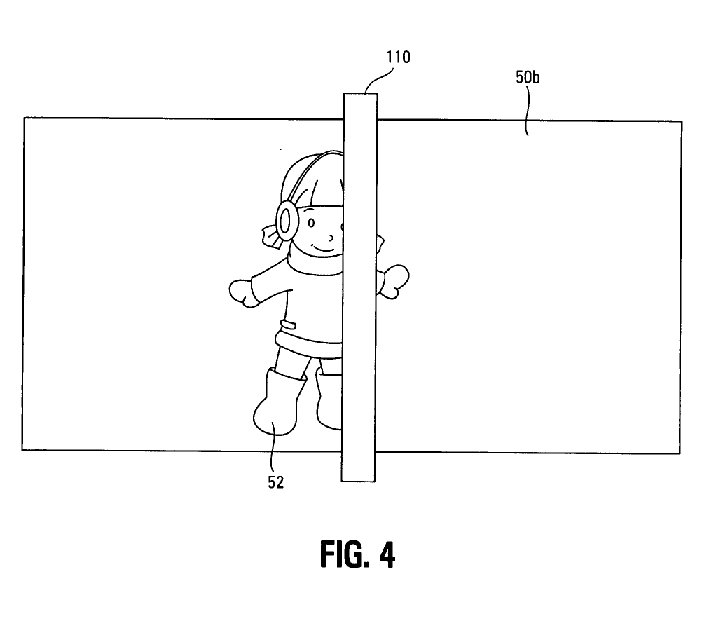

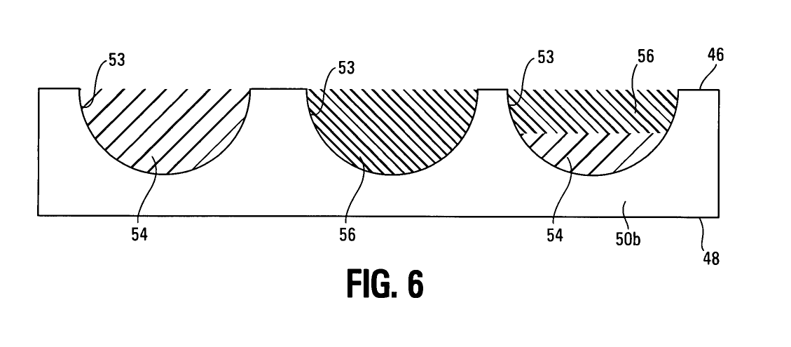

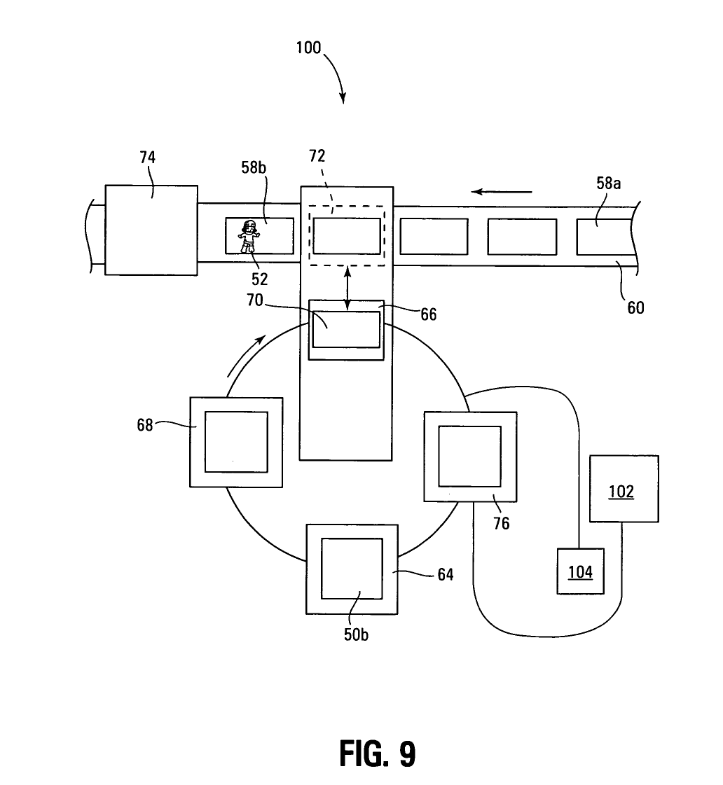

FIG. 1 is a flow chart illustrating the steps of the pad printing method of the present claimed invention. The method optionally begins with the 14 positioning of a generic cliché 50a (as shown in FIG. 2) that has been configured to contain a plurality of etched portions or micro pockets 53 into the inkjet customization area or inking station 76 on the pad printing press 100 as best shown in FIG. 9. In another embodiment, the generic cliché 50a is customized separately and manually attached to the printing press 100. A computer input file (unnumbered) of the graphic design 52 desired to be printed is 16 analyzed and fed to a microprocessor 102 in communication with an inkjet printing head 110. It is emphasized that as shown in FIG. 3, the generic cliché 50a defines micro pockets defining a substantially uniform depth beneath the surface plane 51 of the generic cliché 50a, which is discussed in more detail below. Clichés, generally, are made of ceramic, photopolymer or steel and either chemically or laser etched to create small recesses or micro pockets 53 into a first major surface 46 of the generic cliché 50a, representing the design or graphic 52 wished to be printed. The recesses or micro pockets 53 usually vary in size between about 100 per inch to 3000 per inch and when dealing with multicolor operations require the micro pockets 53 of the different required clichés (not shown) to be of varying depths. This is an involved process considering that the family of clichés must be made in perfect registration with each other. Traditional methods of multicolor pad printing thus require the creation of as many different unique clichés (not shown) as colors required to complete the graphic design 52, leading to increased time consumption, significantly reducing the efficiency and increasing the expense of the printing process. The present claimed invention, to the contrary, requires only the production of a single generic cliché 50a, which can be quickly and exactly reproduced as many times as needed and then further modified for multicolor production by the 18a application of ink jet ink 54 into the designated selected micro pockets which is subsequently 18b cured, allowing it to harden, resulting in the creation of a customized cliché 50b. As shown in FIG. 6, because the ink jet ink 54 will be discharged to some micro pockets 53 but not others, and also because the level of ink jet ink 54 can be at different levels, as shown in FIG. 6, the generic cliché 50a is able to be created having all micro pockets 53 extend to substantially a uniform depth below the surface plane 51 of the generic cliché 50a, resulting in reduced preparation time and subsequent increased cost efficiency. It is understood that embodiments of the invention where the micro pockets 53 of the generic cliché 50a extend to non-uniform depth below the surface plane 51 (not shown) might also be required in some applications, therefore the invention is not limited in scope to only uniform depth micro pockets 53. Using a conventional ink jet printing head 110 as shown in FIG. 4 the micro pockets 53 are selectively and variably 18a filled with ink jet ink 54 to various depths, creating a negative image (not shown) of the graphic design 52 that will eventually be printed onto the substrate 58b. The droplets fired by the inkjet print head 110 can be precisely aligned with the micro pockets 53 on the generic cliché 50a but this is not strictly required. Even if each inkjet droplet is not precisely aligned with a micro pocket 53 the inkjet ink will fill the micro pockets 53 in such a way that a customized cliché 50b is created. Stated another way, generally the resolution of the micro pockets 53 is higher (finer) than the inkjet printing resolution but this is not required. In some applications it may be desirable to have the resolution of the micro pockets 53 be finer or coarser than the resolution of the inkjet image. Generally the inkjet print heads 110 will deposit UV curable ink because of its ease of use, quickness of hardening and ability to withstand wet pad printing ink 56. An important characteristic of inkjet ink 54 is that it must resist wet pad printing ink 56 and also be able to be completely cleaned from the customized cliché 50b in order to return the customized cliché 50b to its generic 50b state. Other types of ink jet inks including thermal cure and solvent based inks could also be used to fill the micro pockets 53 in some applications. Piezo electric print heads from Xaar® and Fuji Dimatix® generally 18a print and 18b cure all in one motion. In most cases a print head and UV light cure light (not shown) are attached to a trolley that scans across the generic cliché 50a. Ink is jetted out and immediately cured by the UV light. Thermal print heads such as those developed by Hewlett Packard® could also be used.

A negative image is required because the nature of the cured ink jet ink 54 is that the pad printing ink 56 in a subsequent step resists adhering to the cured ink jet ink 54, while subsequently adhering to the micro pockets 53 not completely containing cured ink jet ink 54, creating a positive image to be transferred on to the substrate 58a. Pad printing ink 56 can be a process color ink, which is translucent or a spot color ink, which is opaque. Translucent ink allows the creation of full color images by allowing the combination and overlay of different basic colors. Four basic colors of pad printing ink are typically used: cyan, yellow, magenta and black. For example, to create orange, a first cliché (not shown) having a particular pocket 53 will only be partially filled with cured ink jet ink 54 and then partially filled with yellow pad printing ink 56. Similarly, a second cliché (not shown) will also have that particular pocket 53 partially filled with in with ink jet ink 54. The second cliché (not shown) will have its corresponding pocket 53 partially filled in with magenta pad printing ink 56. During the printing process, the first cliché (not shown) will deposit an amount of yellow pad printing ink 56 on the designated area of the substrate 58b, followed, in a second pass by the second cliché (not shown) subsequently depositing an amount of magenta pad printing ink 56 on the same designated area of the substrate 58b, resulting in that portion of the graphic design 52 being orange, due to the translucent nature of the process pad printing ink 56, which allows the colors to appear to combine. Where a pocket 53 is completely filled in, as shown in FIG. 6, no pad printing ink 56 will adhere to the customized cliché 50b. When a pocket 53 is partially filled in a thinner layer of pad printing ink will adhere to the customized cliché 50b creating a lighter color if no overlaying color is subsequently applied, or a mixed color (such as orange) if a second overlaying color is applied.

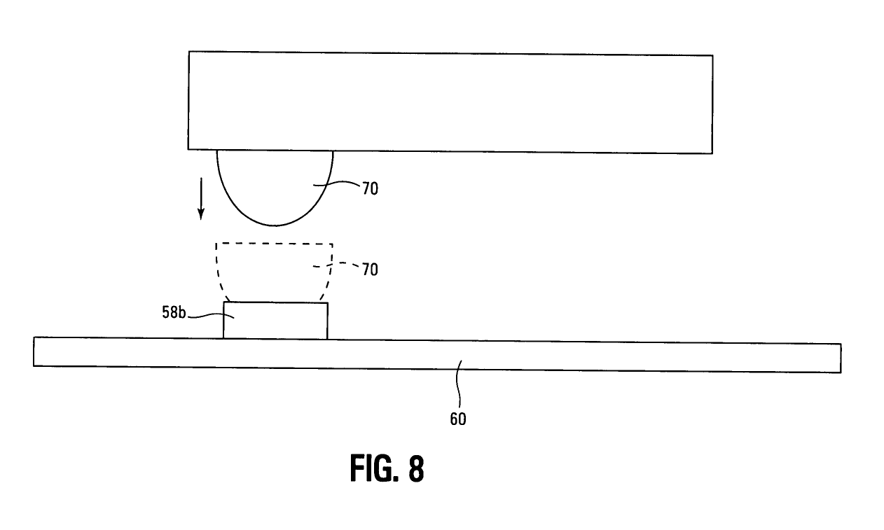

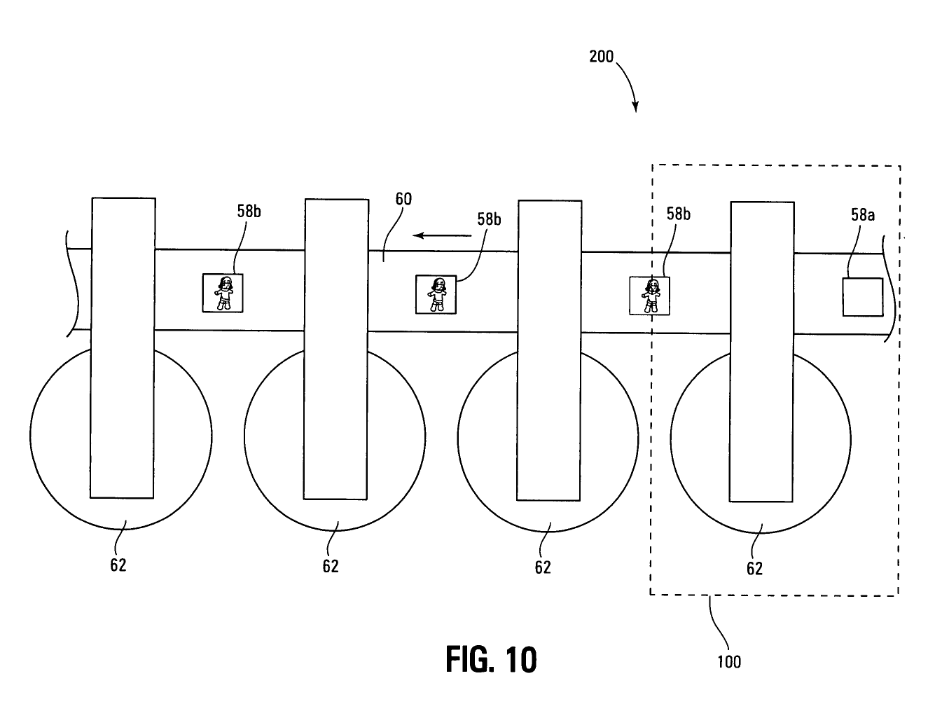

When the ink jet ink is 18b cured and solidified, the cliché 50b is 20 moved to an inking station 68 on the printing press 100 where the customized cliché 50b is 22 contacted with tacky pad printing ink 56. Next, the customized cliché 50b is moved to a position on the printing press 100 where the pad printing inked cliché 50b is 24 contacted by a printing pad 70 as shown in FIG. 8 where the image is transferred from the customized cliché 50b to the printing pad 70. The pad printing inked printing pad 70 is then moved over and down to a position above the substrate 58a prior to printing and then 26a contacts the substrate 58b, resulting in the 26b transfer of the graphic design 52 to the substrate 58b. Following the 26b transfer of the image 52 to the substrate 58b the substrate 58b is moved to the drying station 74 where the image 52 is stabilized. Where a single color graphic design is required, the process is complete. In multicolor operations, as shown in FIG. 10, the printed substrate 58b is moved by a conveyor 60 to a subsequent printing press 100 where the process is repeated with the application of a second and as many colors as necessary to complete the printing operations.

As shown in FIG. 9, the printing pad 70 is moved to a cleaning station 64 where it is also 32 cleaned (not shown), usually by conventional means such as a waste tape surface (not shown) that the printing pad 70 contacts which removes any remaining pad printing ink 56, readying the printing pad 70 for another production cycle.

Finally the substrate 58b is 28a moved to a drying station 74 where it is 28b dried by conventional means (not shown) such as heat or ultraviolet light. Should application of another color be desired, the partially printed substrate 58b is loaded and positioned onto the conveyor 60 for the next printing cycle. In the case of a multi press setup as shown in FIG. 10, the printed substrate 58b remains on the conveyor 60 is 28b dried and is moved to the next press for the subsequent application of another color.

When the production cycle is finished, the customized cliché 50b can optionally be 12 cleaned to remove the cured ink jet ink 54. This step converts the customized cliché 50b back into a generic cliché 50a which can then be re-customized with a different version of the image (representing the negative image of another color to be printed) ink jetting 18a and curing 18b to continue the production run with the printing of another color onto the substrate 58b. This embodiment allows multicolor pad printing operations using a single printing press 100 with the customized cliché 50b being automatically “wiped” and then re-programmed to create a subsequent customized cliché 50b or clichés 50b representing different colors. In another embodiment of the invention, multiple customized cliché 50b are initially created and manually loaded into a printing press 100 to apply each color separately. As best shown in FIG. 10, in an alternative embodiment of the invention, multiple printing presses 100 representing separate colors are set up and are serially connected to each by a conveyor system 60, allowing an automatic multicolor pad printing operation without needing to change or alter customized clichés 50b.

What is claimed is:

1. A method of pad printing, comprising:
(a) providing a generic cliché defining a first surface configured to contain a plurality of micro pockets conforming to a graphic design desired to be transferred to a substrate;
(b) creating a customized cliché by precisely depositing varying amounts of ink jet ink into at least some of the micro pockets in the generic cliché representing areas of the graphic design requiring gray scale tonal control to be printed on an eventually completed part;
(c) curing the ink jet ink to solidify the ink jet ink;
(d) applying a quantity of pad printing ink to the first major surface of the customized cliché;
(e) contacting the customized cliché with the pad printing ink, filling in the micro pockets with amounts of the pad printing ink in inverse proportion to the amount of cured ink jet ink previously deposited in each pocket;
(f) further contacting the customized cliché with a printing pad to transfer the graphic design from the customized cliché to the printing pad; and
(g) moving the pad printing inked printing pad to contact the substrate, thereby transferring the graphic design;
(h) drying the printed substrate; and
(i) following the printing cycle, cleaning the printing pad to prepare for the next cycle.

2. The method of claim 1 wherein the cured ink jet ink is removed from the customized cliché, converting the customized cliché to a generic cliché.

3. The method of claim 2 wherein a second customized cliché is created by precisely depositing varying amounts of ink jet ink into at least some of the micro pockets in the generic cliché representing areas of the graphic design requiring gray scale tonal control to be printed on an eventually completed part.

4. The printing method of claim 1, wherein the ink jet ink is deposited from an ink jet head.

5. The printing method of claim 1 wherein the micro pockets in the generic cliché at step (a) define a substantially uniform depth and in the customized cliché in steps (b) through (i) the micro pockets define varying depths.

6. The cliché of claim 1 wherein the cliché defines a flat two dimensional plane.

7. The cliché of claim 1 wherein the ink jet ink is deposited by an ink jet printing head.

8. A cliché for use in pad printing, comprising:
(a) a plate defining a first major surface defining a surface plane;
(b) a region on the first major surface representing a graphic image formed by a plurality of micro pockets extending below the surface plane of the first major surface;
(c) at least partially, precisely depositing varying amounts of ink jet ink into at least some of the micro pockets in the cliché representing areas of the graphic design requiring gray scale tonal control of an eventually completed part;
wherein the ink jet ink is hardened by being cured, resulting in a three dimensional structure below the surface plane which, when contacted with a quantity of pad printing ink, the pad printing ink is transferred from the cliché in a manner reflecting a variation of intensity of color, to a printing pad maintaining the variation of intensity of color and finally from the printing pad to a substrate maintaining the variation of intensity of color.

9. The cliché of claim 8 wherein the ink jet ink is deposited by an ink jet printing head.

10. The cliché of claim 8 wherein the ink jet ink is cured by exposure to ultraviolet light.

11. The cliché of claim 8 wherein the micro pockets in the generic cliché define a substantially uniform depth.

12. A printing apparatus comprising:
(a) a platform containing a plurality of functional stations able to move to various positions, the platform configured to precisely hold a cliché configured with a plurality of micro pockets, the micro pockets containing precisely deposited varying amounts of ink jet ink into at least some of the micro pockets in the cliché representing areas of the graphic design requiring gray scale tonal control to be printed on an eventually completed part, the ink jet ink hardened by being cured;
(b) an inking station mounted on the platform to provide pad printing ink to the cliché;
(c) a transfer station containing a printing pad able to contact the pad printing inked cliché to transfer the pad printing ink from the cliché to the printing pad; and
(d) a printing station where the pad printing inked printing pad transfers the pad printed ink to a substrate desired to be printed.

13. The printing apparatus of claim 12 further comprising an ink jet station able to precisely deposit ink jet ink onto a generic cliché.

14. The printing apparatus of claim 12 further comprising a curing station to cure the deposited ink jet ink to create a customized cliché.

15. The printing apparatus of claim 12 further comprising a second cleaning station for cleaning any remaining pad printing ink from the printing pad following a printing cycle.

16. The printing apparatus of claim 12 further a drying station for drying a printed part following a printing cycle.

17. The printing apparatus of claim 12 wherein the platform comprises a turntable capable of rotating to the various stations to change functions during a printing operation.

18. The printing apparatus of claim 12 wherein multiple printing presses are serially attached together by a conveyor system, allowing multi-color printing operations.

19. The printing apparatus of claim 12 further comprising an ink jet head for precisely varying amounts of ink jet ink into at least some of the micro pockets in the cliché.

20. The printing apparatus of claim 12 further comprising a computer capable of storing files of images desired to be printed and for controlling the ink jet head when depositing ink jet ink into the micro pockets.
